(19) United States
(12) Patent Application Publication
(10) Pub. No.: US 2008/0019025 A1
(43) Pub. Date: Jan. 24, 2008

(54) Objective Lens Drive

(76) Inventors: Yutaka Murakami, Osaka (JP); Hironori Tomita, Nara (JP)

Correspondence Address: WENDEROTH, LIND & PONACK L.L.P., 2033 K. STREET, NW, SUITE 800, WASHINGTON, DC, 20006, US

(21) Appl. No.: 11/665,560

(22) PCT Filed: Aug. 5, 2005
(86) PCT No.: PCT/JP05/14401

§ 371 Date: Apr. 17, 2007

(30) Foreign Application Priority Data
Oct. 19, 2004 (JP) 2004-304088

(51) Int. Cl. G02B 7/04

(52) U.S. Cl. 359/813

(57) ABSTRACT

An objective lens drive is provided which is capable of reducing a primary resonance frequency in the tracking direction while suppressing lowering of a buckling resonance frequency in the focus direction. In this objective lens drive: an objective lens secured to an objective lens holder is displaced relatively to a securing member in the focus direction and tracking direction through bending deformation of resilient supporting members; each resilient supporting member is provided with a trapezoidal portion in which the width in the tracking direction becomes narrower toward the end of the resilient supporting member; and the trapezoidal portion has a length of 27-50% of the effective length of the resilient deformation portion.

### TECHNICAL FIELD

The present invention relates to an objective lens drive which is used for an optical head.

### BACKGROUND ART

There is an optical disk unit in which a disk-shaped optical record medium (hereinafter, referred to simply as an optical disk), including an optical disk and an optical magnetic disk, such as a DVD, a CD and a mini-disk (hereinafter, referred to simply as an MD), is used as a record medium. Such an optical disk unit includes an optical head for regenerating an information signal recorded in an optical disk, or recording the information signal. This optical head is provided with: a semiconductor laser as a light source which emits a luminous flux applied to the information record surface of the optical disk; a beam splitter which splits a return beam from the optical disk; an optical block which is made up of a hologram element and the like; and an objective lens drive which allows an objective lens to concentrate a luminous flux emitted from the semiconductor laser upon the optical disk's information record surface and allows the luminous flux to follow the information track.

When the optical disk rotates, its surface can sway and its center may deviate from the rotation center. In order to allow the objective lens to track on the swaying surface and according to the deviating center, the objective lens drive moves and adjusts the objective lens in the direction perpendicular to the information record surface or the focus direction, and in the direction parallel to the optical disk's information record surface and perpendicular to the information track, or the tracking direction which corresponds to the optical disk's inner and outer circumferential direction. This objective lens drive moves the objective lens, for example, within a range of 2 mm in the focus direction and 1 mm in the tracking direction. Thereby, it adjusts the objective lens's position. Hence, the objective lens drive is provided with a crossed biaxial actuator mechanism. This crossed biaxial actuator mechanism supplies a coil provided in a magnetic field with a control electric current. This generates an electromagnetic force, and using this force, the objective lens is moved in the focus direction and in the tracking direction.

As such a crossed biaxial actuator mechanism put to practical use, there are a spring supporting system in which no friction is produced and a smooth drive characteristic can be obtained, and an axial sliding system which can be easily assembled with precision and is excellent in maintaining the inclination of an objective lens.

In a crossed biaxial actuator mechanism where the above described spring supporting system is used, a hinge-type structure, a wire-type structure or a plate spring structure is known as the structure of a resilient supporting member which holds an objective lens. Taking into account its workability, operation characteristics or the like, a crossed biaxial actuator mechanism which has a plate spring structure is extremely effective in making an objective lens drive smaller.

A conventional objective lens drive which includes such a crossed biaxial actuator mechanism with a plate spring structure is described in Patent Document 1.

Hereinafter, this conventional objective lens drive will be described using FIG. 15 to FIG. 18. FIG. 15 is a perspective view of the whole of an example of the conventional objective lens drive. FIG. 16 is a plan view of its entire part. FIG. 17 is a perspective view of a resilient supporting member, though a part of it is omitted, which is provided in the same objective lens drive and which makes up a biaxial actuator that supports an objective lens so that it can be freely displaced in the focus direction and tracking direction. FIG. 18 is a top view of the conventional objective lens drive, showing a resonance mode (i.e., a buckling resonance frequency) in the yawing directions in a numerical analysis by the finite element method.

In FIG. 15 to FIG. 18, an objective lens 1 is formed in a glass press or resin molding. This objective lens 1 is secured to an objective lens holder 2, by means of an adhesive agent. The objective lens holder 2 is molded out of resin and is provided with a hole which the -objective lens 1 is inserted into. To the objective lens holder 2, a focus coil 3 which is wound around the Z-axis and tracking coils 4A, 4B which are wound around the X-axis are secured by means of an adhesive agent. These objective lens 1, objective lens holder 2, focus coil 3 and tracking coils 4A, 4B make up a movable portion 5.

A resilient supporting member 60 is formed by a thin plate-spring material. One end of it is secured to a side surface of the objective lens holder 2, and the other end is fixed to a securing member 7 secured on a base member 8. The resilient supporting member 60 supports the movable portion 5 so that it can be displaced in the focus direction (i.e., the Z-axis direction) and the tracking direction (i.e., the Y-axis direction). Incidentally, the securing member 7 is molded out of resin.

The resilient supporting member 60 is formed by blanking a metal plate in sheet-metal press working. This metal plate is made of phosphor bronze, beryllium copper or the like, and thus, it is excellent in both conductivity and spring characteristics. This resilient supporting member 60 is also used for passing an electric current through the focus coil 3 and the tracking coils 4.

In the resilient supporting member 60, as shown in FIG. 17, a U-shaped turning-back portion 70 is formed at the end on the side of the securing member 7. Thereby, the effective length of the resilient supporting member 60 is L10+L20.

The base member 8 is made of ferromagnetic metal, such as iron. It is provided with a yoke 9A and a yoke 9B which face each other so that the focus coil 3 and the tracking coils 4 are sandwiched between them. To the yoke 9A and the yoke 9B, a permanent magnet 10A and a magnet 10B are secured by means of an adhesive agent. In terms of these magnets 10A, 10B, their magnetic poles are oriented in the X-axis direction, and in addition, their surfaces opposite to each other have a different magnetic pole. These yokes 9A, 9B, permanent magnet 10A and magnet 10B make up a magnetic circuit portion 40.

In such an objective lens drive 901 as configured like this, if an electric current according to a focus error signal is supplied to the focus coil 3, this electric current which flows through the focus coil 3 and a magnetic flux from the permanent magnet 10A and the magnet 10B which make up the magnetic circuit portion 40 produces an electro-magnetic driving force which drives the movable portion 5 in the focus direction. This electro-magnetic driving force moves the objective lens 1 in the focus direction parallel to the optical axis. Thereby, a focus adjustment is made for a semiconductor laser beam which irradiates an optical disk. When the focus adjustment operation is executed, the resilient supporting member 60 whose end is secured to the securing member 7 is deformed by its resilience in the Z-axis direction (i.e., the focus direction) shown in FIG. 15. This adjusts the position of the movable portion 5, in other words, the objective lens 1 in the Z-axis direction.

In addition, in this objective lens drive 901, if an electric current according to a tracking error signal is supplied to the first tracking coil 4A or the second tracking coil 4B, this electric current which flows through a part parallel to the objective lens l's optical axis in the first tracking coil 4A or the second tracking coil 4B and the magnetic flux of the permanent magnet 10A which forms a part of the magnetic circuit portion 40 produces a magnetic driving force which drives the movable portion 5 in the tracking direction (i.e., the Y-axis direction). This magnetic driving force adjusts the objective lens 1 in the tracking direction perpendicular to the optical axis. Thereby, a tracking adjustment is made for a semiconductor laser beam which irradiates an optical disk. When the tracking adjustment operation is executed, the resilient supporting member 60 whose end is secured to the securing member 7 is deformed by its resilience in the Y-axis direction (i.e., the tracking direction) shown in FIG. 15. This adjusts the position of the movable portion 5, in other words, the objective lens 1 in the Y-axis direction.

The displacement of the movable portion 5 in the focus direction and the tracking direction according to an input electric current is substantially constant in a low frequency band. However, in a high frequency band beyond a specific frequency, the higher the frequency becomes, the smaller its sway will be at an inclination of −40 dB/dec. This specific frequency, in other words, a primary resonance frequency (f0), is substantially determined according to the weight of the movable portion 5 and the Young's modulus and shape of the resilient supporting member 60. For example, it is inversely proportional to the resilient supporting member 60's effective length to the ⅔ power.

As the primary resonance frequency (f0) becomes higher, the displacement of the movable portion 5 according to an input electric current becomes shorter in a low frequency band. Therefore, in the conventional objective lens drive 901, on the side of the securing member 7, the U-shaped turning-back portion 70 is provided in the resilient supporting member 60. This helps lengthen the effective length of the resilient supporting member 60, so that the primary resonance frequency can be lowered especially in the focus direction.

Patent Document 1: Japanese Patent Laid-Open No. 8-83433 specification

However, according to the above described conventional configuration, in the resilient supporting member 60, the turning-back portion 70 is formed on the side of the securing member 7. This raises disadvantages in that the structure of a die becomes complicated, the yield is reduced when the resilient supporting member 60 is manufactured, and the lifetime of a die shortens.

The objective lens drive 901 has a resonance frequency even in a frequency band higher than the above described primary resonance frequency. As shown in FIG. 18, the resilient supporting member 60 buckles in the X-axis direction. Then, in a yawing-mode resonance (i.e., a buckling resonance) where the movable portion 5 turns in the X-Y plane, the objective lens 1 vibrates in the Y-axis directions. This affects the servo characteristic in the tracking direction. Especially, if the buckling resonance frequency which is the above described yawing-mode resonance frequency is located near a gain crossover frequency (usually, set at a range from 500 Hz to 1.5 kHz) which is a frequency where a servo gain becomes zero, that affects the servo characteristic greatly. Therefore, the buckling resonance frequency needs to be a frequency far higher than the gain crossover frequency. However, according to the above described conventional configuration, the turning-back portion 70 is provided, so that the resilient supporting member 60's rigidity deteriorates against a buckle. Thereby, the buckling resonance frequency is lowered as well. This raises a disadvantage in that the buckling resonance frequency comes closer to the gain crossover frequency of the servo, and thus, the servo characteristic becomes unstable.

Herein, in terms of the resilient supporting member 60 provided with the turning-back portion 70 shown in FIG. 17 and a resilient supporting member 61 formed by only a straight portion shown in FIG. 19, a resonance frequency is numerically calculated using the finite element method. If the effective length of a suspension is L30(=L10+L20)=8.6 mm, the width b1=b2=b3=0.08 mm and the thickness t=0.05 mm, then in the resilient supporting member 60 provided with the turning-back portion 70, a calculation indicates that the primary resonance frequency in the focus direction is 36 Hz, the primary resonance frequency in the tracking direction is 47 Hz and the buckling resonance frequency is 1.2 kHz.

In contrast, in the resilient supporting member 61 formed by only the straight portion, the primary resonance frequency in the focus direction is 37 Hz, the primary resonance frequency in the tracking direction is 50 Hz and the buckling resonance frequency is 3.6 kHz. Hence, the buckling resonance frequency is 3.3 times as high as that in the case where the turning-back portion 70 is provided. It can be seen from this calculation result alone that in the resilient supporting member 60 provided with the turning-back portion 70, the buckling resonance frequency comes closer to the gain crossover frequency in the tracking direction.

In addition, portable equipment has recently been popular, which prompts such equipment to be smaller, as well as urges its power consumption to be reduced. If such equipment has a high primary resonance frequency, then the rigidity of a resilient supporting member becomes great, thus increasing the power consumption for a control operation. On the other hand, if portable equipment has a low primary resonance frequency, the movable portion 5 is largely displaced when a disturbance such as an impact is given from the outside. This can raise a disadvantage in that an objective lens may hit and scratch an optical disk. From this point of view, it is desirable that the primary resonance frequency in the focus direction be set between 30 Hz and 40 Hz.

However, in sheet-metal press working, desirably, in order to maintain productivity, the spring-range width of a resilient supporting member should be 1.3 or more times as great as its sheet thickness. Hence, if the primary resonance frequency in the focus direction is 30 Hz or above, the primary resonance frequency in the tracking direction becomes higher, thus raising the power consumption for a control operation in the tracking direction.

### DISCLOSURE OF THE INVENTION

In order to resolve the above described conventional disadvantages, it is an object of the present invention to provide an objective lens drive which is capable of reducing a primary resonance frequency in the tracking direction while suppressing lowering of a primary resonance frequency and a buckling resonance frequency in the focus direction.

In order to attain this object, an objective lens drive according to the present invention in which an objective lens holder is held to a plurality of resilient supporting members supported on a securing member, and an objective lens secured to this objective lens holder is displaced in the focus direction and tracking direction through bending deformation of the resilient supporting members, characterized in that, each resilient supporting member is provided with a trapezoidal portion in which the width in the tracking direction becomes narrower toward the end of the resilient supporting member.

According to the present invention, the resilient supporting member is provided with a trapezoidal portion in which the width in the tracking direction becomes narrower toward the end of the resilient supporting member. Therefore, it can be kept rigid in the focus direction while being less rigid in the tracking direction. Hence, it can be prevented from being excessively displaced in the focus direction, and at the same time, the primary resonance frequency can be reduced in the tracking direction. This makes it possible to prevent an objective lens from hitting on an optical disk, and simultaneously, decrease the power consumption when a control operation is executed in the tracking direction. Besides, the buckling resonance frequency can be kept higher than that in the case where a turning-back portion is provided. This helps prevent the servo characteristic from being unstable.

In short, in the objective lens drive according to the present invention, the rigidity against a buckle can be kept high and the primary resonance frequency in the tracking direction can be lowered.

### BRIEF DESCRIPTION OF THE DRAWINGS

FIG. 1 is a perspective view of an objective lens drive according to a first embodiment of the present invention.

FIG. 2 is a top view of the objective lens drive.

FIG. 3 is a perspective view of a resilient supporting member provided in the objective lens drive.

FIG. 4 is a representative showing a mode in which the resilient supporting member resonates at a primary resonance frequency in the focus direction.

FIG. 5 is a representative showing a mode in which the resilient supporting member resonates at a primary resonance frequency in the tracking direction.

FIG. 6 is a representative showing a mode in which the resilient supporting member resonates at a yawing-mode resonance frequency (i.e., a buckling resonance frequency).

FIG. 7 is a perspective view of an objective lens drive according to a second embodiment of the present invention.

FIG. 8 is a perspective view of a resilient supporting member provided in the objective lens drive.

FIG. 9 is a graphical representation, showing the characteristic relation between the percentage of a trapezoidal portion and a resonance-frequency relative value in the tracking direction.

FIG. 10 is a perspective view of an objective lens drive according to a third embodiment of the present invention.

FIG. 11 is a perspective view of a resilient supporting member provided in the objective lens drive.

FIG. 12 is a graphical representation, showing the characteristic relation between a ratio w1/w2 and a resonance-frequency relative value.

FIG. 13 is a perspective view of an objective lens drive according to a fourth embodiment of the present invention.

FIG. 14 is a perspective view of a resilient supporting member provided in the objective lens drive.

FIG. 15 is a perspective view of a conventional objective lens drive.

FIG. 16 is a top view of the conventional objective lens drive.

FIG. 17 is a perspective view of a resilient supporting member provided in the conventional objective lens drive.

FIG. 18 is a representation, showing a mode in which the resilient supporting member resonates at a yawing-mode resonance frequency (i.e., a buckling resonance frequency).

FIG. 19 is a perspective view of a resilient supporting member which has only a straight portion.

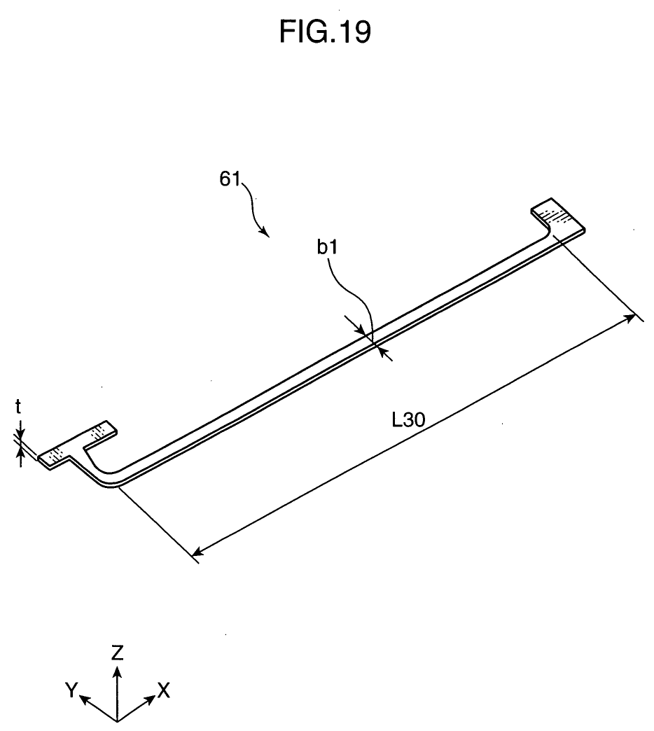

### BEST FOR IMPLEMENTING THE INVENTION

Hereinafter, the best mode for embodying the present invention will be described in detail with reference to the attached drawings.

### First Embodiment

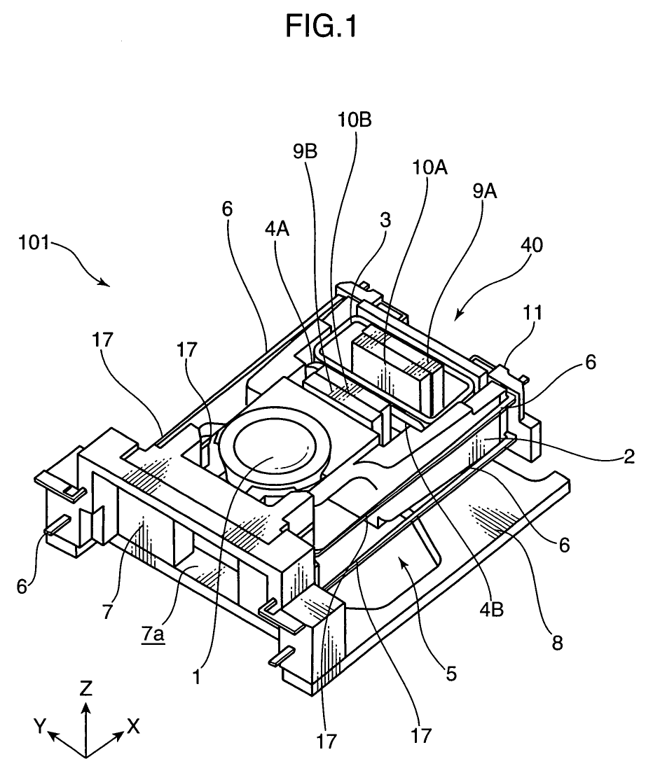

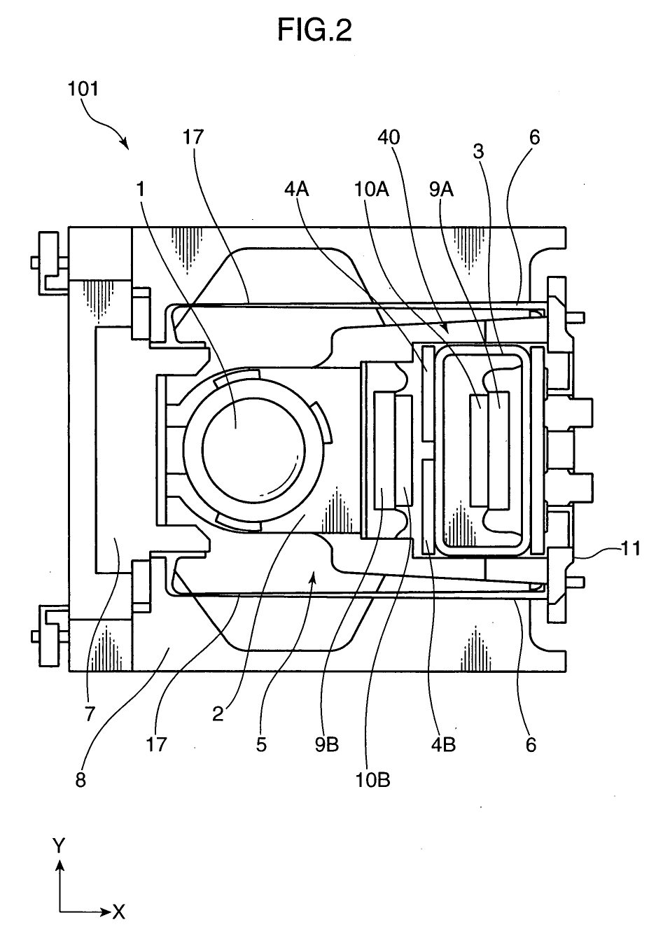

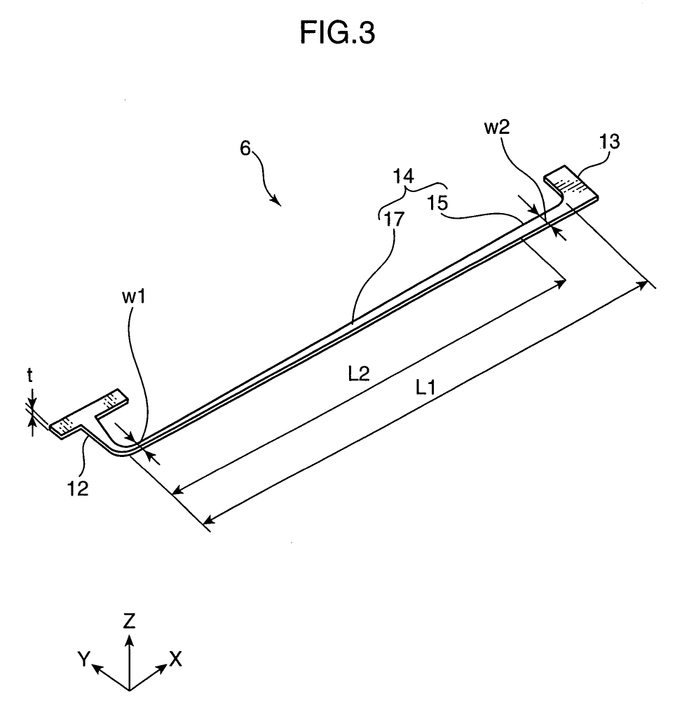

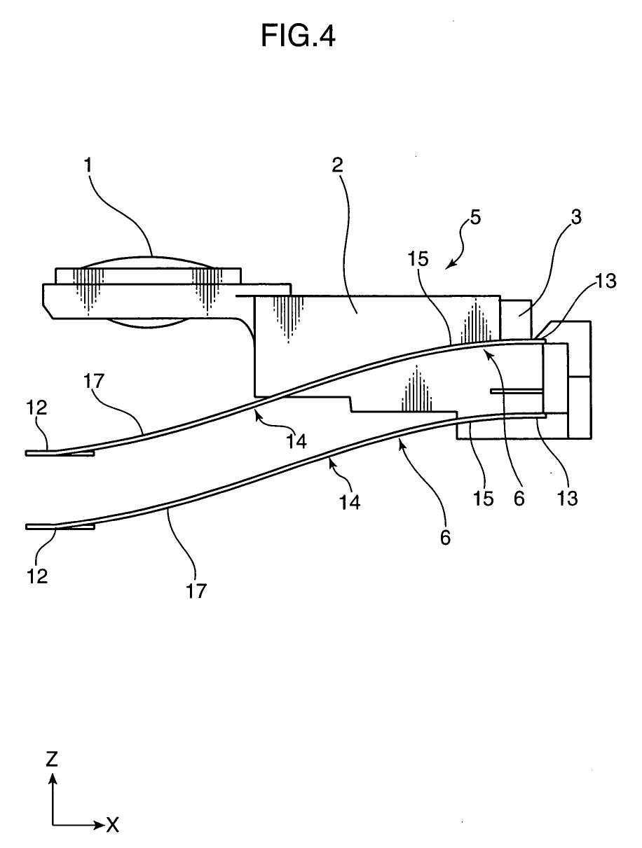

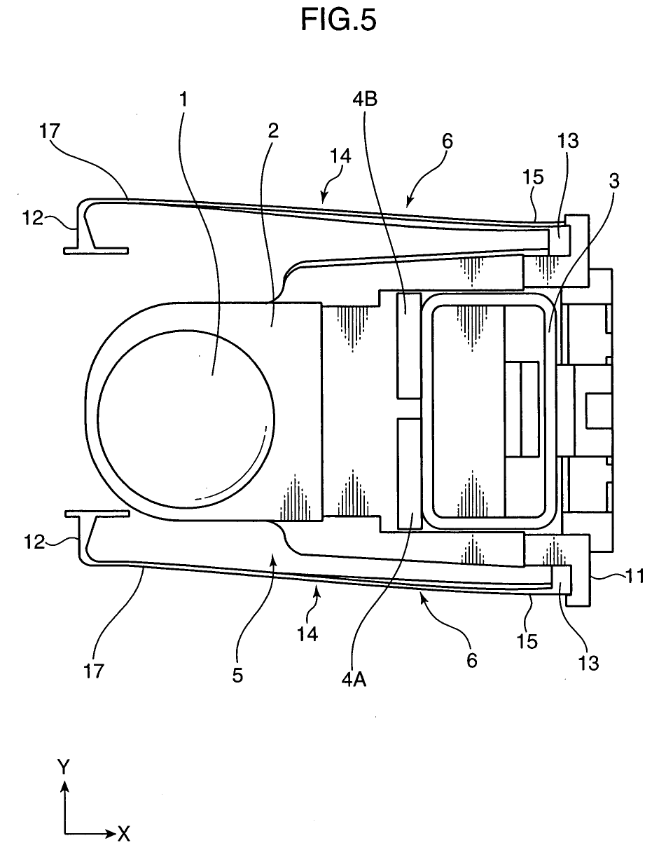

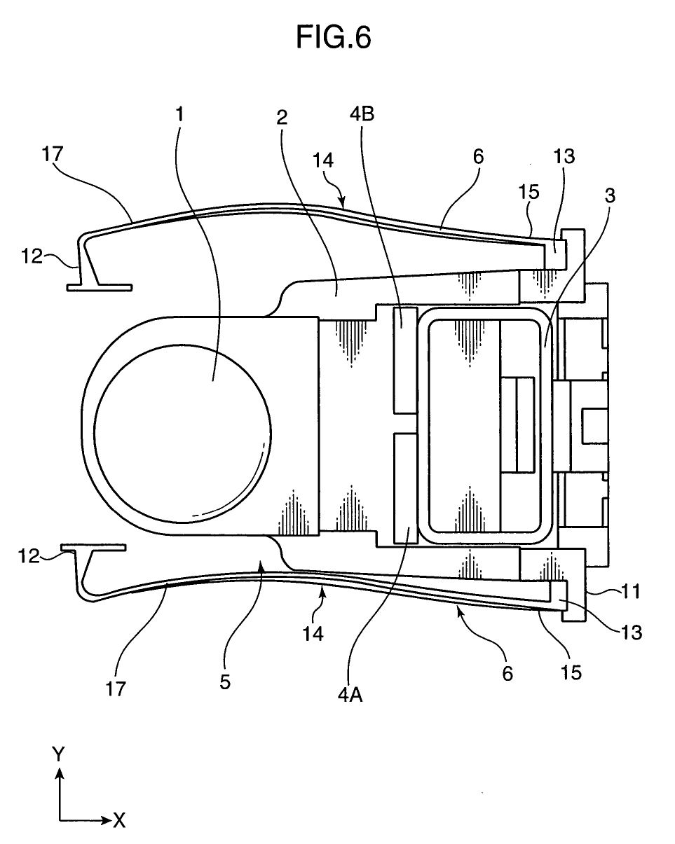

FIG. 1 is a perspective view of an objective lens drive 101 according to a first embodiment of the present invention. FIG. 2 is a top view of the objective lens drive 101 of FIG. 1. FIG. 3 is a perspective view of a resilient supporting member 6 provided in the objective lens drive of FIG. 1, though a part of it is omitted. This resilient supporting member 6 is disposed in a biaxial actuator which supports an objective lens 1 so that it can be freely displaced in the focus direction and in the tracking direction. FIG. 4 is a partial side view of the objective lens drive 101 of FIG. 1, showing a resonance mode at a primary resonance frequency in the focus direction. FIG. 5 is a partial top view of the objective lens drive 101 of FIG. 1, showing a resonance mode at a primary resonance frequency in the tracking direction. FIG. 6 is a partial top view of the objective lens drive 101 of FIG. 1, showing a resonance mode at a yawing-mode resonance frequency (i.e., a buckling resonance frequency). In FIG. 1 to FIG. 6, the X-axis indicates the track tangential direction of an optical disk, the Y-axis represents the tracking direction, and the Z-axis expresses the focus direction.

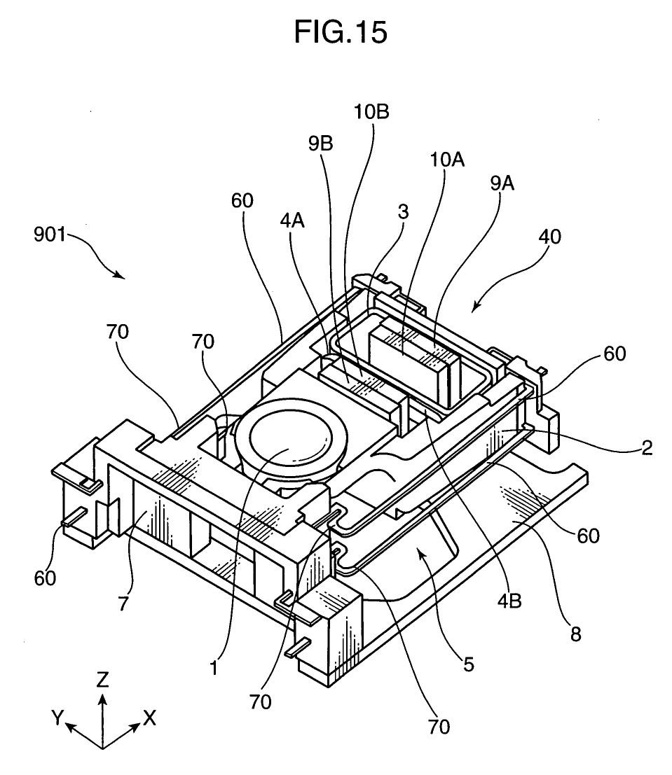

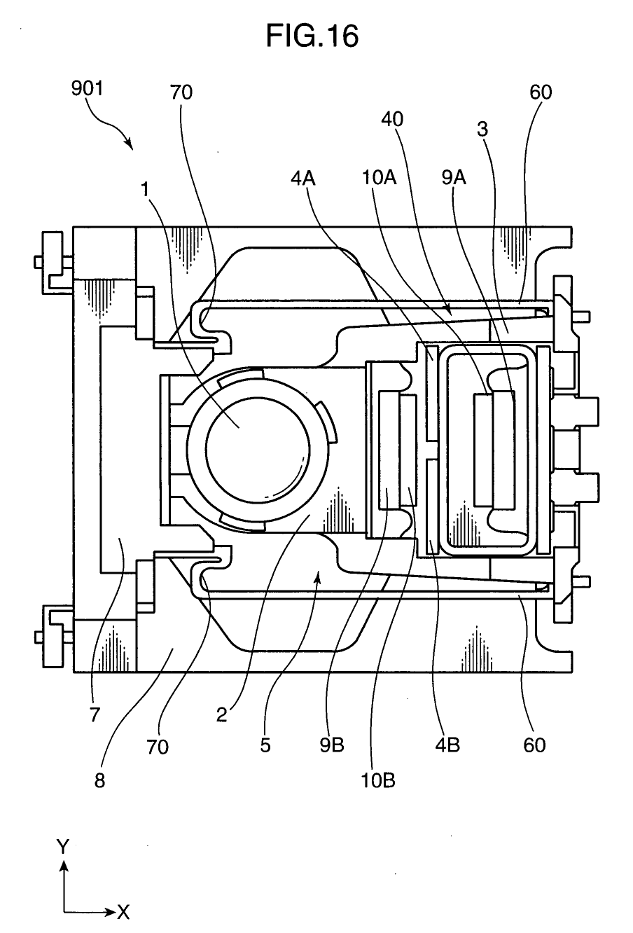

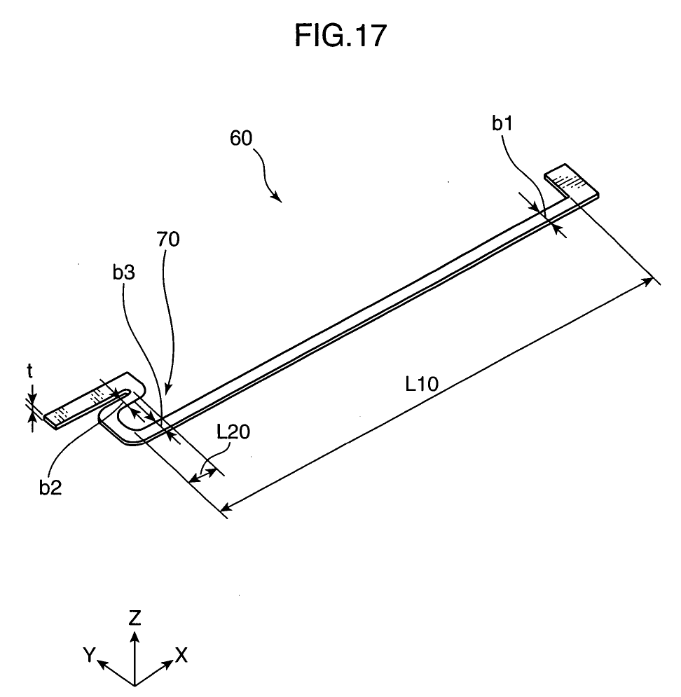

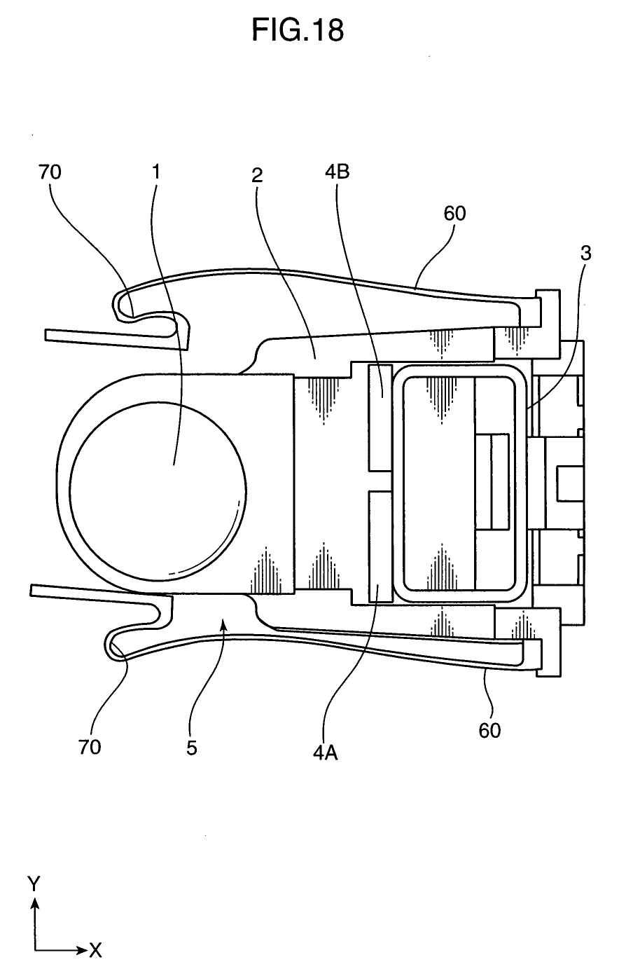

Herein, component elements are given the same reference characters and numerals as those according to the prior art shown in FIG. 15 to FIG. 18, and thus, their detailed description is omitted.

As shown in FIG. 1 to FIG. 6, the objective lens drive 101 includes a base member 8, a securing member 7 secured to this base member 8, resilient supporting members 6, and an objective lens holder 2 resiliently supported on the securing member 7 by these resilient supporting members 6.

The objective lens holder 2 is molded out of resin. In this objective lens holder 2, a hole is formed which the objective lens 1 is inserted into. The objective lens 1 is secured to the objective lens holder 2, by means of an adhesive agent. The objective lens 1 is formed in a glass press or resin molding.

To the objective lens holder 2, a focus coil 3 which is wound around the Z-axis and tracking coils 4A, 4B which are wound around the X-axis are secured by means of an adhesive agent. These objective lens 1, objective lens holder 2, focus coil 3 and tracking coils 4A, 4B make up a movable portion 5 which can be displaced with respect to the securing member 7.

The resilient supporting members 6 are each formed by a thin plate-spring material. In each resilient supporting member 6, one end is secured to a support portion 11 provided in the objective lens holder 2, and the other end is fixed to the securing member 7. The resilient supporting member 6 supports the movable portion 5 so that it can be displaced in the focus direction and in the tracking direction. Specifically, the securing member 7 is located at one end of the base member 8 in the X-axis directions. On the other hand, the support portion 11 of the objective lens holder 2 is placed in the objective lens holder 2, so that it is located opposite to the securing member 7 in the X-axis directions. Then, each resilient supporting member 6 is disposed along the X-axis directions. These resilient supporting members 6 are each placed so as to form a rectangle long sideways, if seen in the X-axis directions. The objective lens holder 2 lies between the resilient supporting members 6 which are located on both sides in the tracking direction.

The objective lens holder 2 and the securing member 7 are each molded out of resin. The resilient supporting members 6 are each united with the objective lens holder 2 and the securing member 7, by means of insertion molding.

The resilient supporting member 6 is formed by blanking a metal plate in sheet-metal press working. This metal plate is made of phosphor bronze, beryllium copper or the like, and thus, it is excellent in both conductivity and spring characteristics. One end of the resilient supporting member 6 is joined to the focus coil 3 and the tracking coils 4, by means of soldering. In other words, the resilient supporting member 6 is designed so that an electric current is sent thereto.

As shown in FIG. 3, in the resilient supporting member 6, the part between a base-end portion 12 which protrudes from the securing member 7 and a front-end portion 13 which juts out from the support portion 11 is formed as a resilient deformation portion 14 which is deformed by its resilience so that the objective lens 1 can be moved. The base-end portion 12 projects in the Y-axis direction from the securing member 7. To this base-end portion 12, the resilient deformation portion 14 is linked so as to be bent from there. Then, the resilient deformation portion 14 extends in a straight line in the X-axis direction. The front-end portion 13 is wider than the resilient deformation portion 14. Incidentally, each resilient supporting member 6 has the same configuration.

The resilient deformation portion 14 includes a straight portion 15 linked to the front-end portion 13, and a trapezoidal portion 17 which continues to this straight portion 15 and is linked to the base-end portion 12. In the straight portion 15, the width in the tracking direction is uniform over the entire longitudinal directions. This straight portion 15's width is assumed to be w2. The trapezoidal portion 17 is a part which has a trapezoidal shape, if seen in the Z-axis directions. In the trapezoidal portion 17, the end part linked to the straight portion 15 has a width w2, the other end linked to the base-end portion 12 has a width w1 narrower than the width w2. In other words, the trapezoidal portion 17 becomes narrower toward the end part from the middle part of the resilient deformation portion 14. As a result, the trapezoidal portion 17 is formed so that at the end on the side of the securing member 7, the width in the tracking direction becomes narrower. The resilient supporting member 6 has a thickness t in the Z-axis directions, and the value of the width in the Y-axis directions is greater than the thickness t. The effective length of the resilient supporting member 6, more specifically, the effective length of the resilient deformation portion 14 is assumed to be L1 and the effective length of the trapezoidal portion 17 is assumed to be L2. Such an effective length means the length of a part which, when the objective lens 1 is displaced in the Z-axis direction (i.e., the focus direction), contributes to this displacement.

The above described base member 8 is made of ferromagnetic metal, such as iron. The base member 8 is provided with a yoke 9A and a yoke 9B which face each other so that the above described focus coil 3 and the tracking coils 4A, 4B are sandwiched between them. To the yoke 9A and the yoke 9B, a permanent magnet 10A and a magnet 10B are secured by means of an adhesive agent. In terms of these magnets 10A, 10B, their magnetic poles are each oriented in the X-axis direction, and in addition, their surfaces opposite to each other have a different magnetic pole. These yokes 9A, 9B, permanent magnet 10A and magnet 10B make up a magnetic circuit portion 40.

In the securing member 7, a through hole 7a (see FIG. 1) is formed which penetrates in the X-axis directions. A luminous flux which is emitted from a semiconductor laser provided in an optical system block out of the figure's range is designed to pass through this through hole 7a. In the objective lens holder 2, a mirror (not shown) inclined at 45 degrees is provided below the objective lens 1 in FIG. 1. This mirror reflects the luminous flux which has passed through the through hole 7a, so that it is incident upon the objective lens 1. Specifically, the luminous flux emitted from the semiconductor laser passes through the through hole 7a of the securing member 7. Then, it is incident in the X-axis direction with respect to the objective lens drive 101. This luminous flux's direction is changed, by the mirror, from the X-axis direction to the Z-axis direction. Then, it is incident upon the objective lens 1. This luminous flux is concentrated upon the information record surface of an optical disk (not shown).

In such an objective lens drive 101 configured as described above, if an electric current according to a focus error signal is supplied to the focus coil 3, this electric current which flows through the focus coil 3 and a magnetic flux from the permanent magnet 10A and the magnet 10B which make up the magnetic circuit portion 40 produces an electro-magnetic driving force which drives the movable portion 5 in the focus direction (i.e., the Z-axis direction). This electro-magnetic driving force moves the objective lens 1 in the focus direction parallel to the optical axis. Thereby, a focus adjustment is made for a semiconductor laser beam which irradiates an optical disk. When the focus adjustment operation is executed, the resilient supporting member 6 whose end is secured to the securing member 7 is deformed by its resilience in the Z-axis direction (i.e., the focus direction) shown in FIG. 1. Thereby, the objective lens holder 2 is displaced relatively to the securing member 7. This makes it possible to adjust the position of the movable portion 5, in other words, the objective lens 1 in the Z-axis direction.

In addition, in this objective lens drive 101, if an electric current according to a tracking error signal is supplied to the first tracking coil 4A or the second tracking coil 4B, this electric current which flows through a part parallel to the objective lens 1's optical axis in the first tracking coil 4A or the second tracking coil 4B and the magnetic flux of the permanent magnet 10 which forms a part of the magnetic circuit portion 40 produces an electromagnetic driving force which drives the movable portion 5 in the tracking direction (i.e., the Y-axis direction). This electro-magnetic driving force adjusts the objective lens 1 in the tracking direction perpendicular to the optical axis. Thereby, a tracking adjustment is made for a semiconductor laser beam which irradiates an optical disk. When the tracking adjustment operation is executed, the resilient supporting member 60 whose end is secured to the securing member 7 is deformed by its resilience in the Y-axis direction (i.e., the tracking direction) shown in FIG. 1. Thereby, the objective lens holder 2 is displaced relatively to the securing member 7. This makes it possible to adjust the position of the movable portion 5, in other words, the objective lens 1 in the Y-axis direction.

The length of a displacement of the movable portion 5 in the focus direction or in the tracking direction according to an input electric current is substantially constant in a low frequency band. However, in a high frequency band beyond a specific frequency, the higher the frequency becomes, the smaller its sway will be at an inclination of −40 dB/dec. This specific frequency, in other words, a primary resonance frequency (f0), is generated even when an adjustment is made in the focus direction or even when an adjustment is made in the tracking direction. Besides, when an adjustment is made in the tracking direction, in a frequency band higher than the primary resonance frequency, a buckling resonance is produced which corresponds to a resonance mode where the resilient supporting member 6 buckles in the X-axis direction and the movable portion 5 turns in the X-Y plane.

The primary resonance in the focus direction is, as shown in FIG. 4, a mode in which the resilient supporting member 6 is deformed in the Z-axis directions. The four resilient supporting members 6 are disposed to be parallel to each other, and thus, in this mode, each resilient deformation portion 14 turns into a secondary bending mode. Thereby, the objective lens 1 moves parallel to the focus direction. The primary resonance frequency in the focus direction is hardly affected by the fact that the trapezoidal portion 17 is provided and the resilient deformation portion 14's width differs in the longitudinal directions.

The primary resonance in the tracking direction is, as shown in FIG. 5, a mode in which the resilient supporting member 6 is deformed in the Y-axis directions. In this mode, a stress is applied, especially, on the end part. Hence, since the trapezoidal portion 17 is provided, the primary resonance frequency lowers in the tracking direction.

At a yawing-mode resonance frequency (i.e., a buckling resonance frequency), as shown in FIG. 6, the resilient deformation portion 14 of the resilient supporting member 6 buckles and bends to be shaped like an S-letter. Thus, the objective lens holder 2 vibrates in the X-Y plane. At this time, the resilient deformation portion 14 is deformed most largely near its middle in the longitudinal directions (i.e., the X-axis directions). Therefore, even if the resilient deformation portion 14 is provided, in such a manner that its width becomes narrower at the end, with the trapezoidal portion 17, that does not affect the buckling resonance frequency so much.

In terms of the objective lens drive 101 including the resilient supporting member 6 shown in FIG. 3, a resonance frequency is numerically calculated using the finite element method. This numerical calculation is made by assuming the resilient deformation portion 14's effective length L1=8.6 mm, the trapezoidal portion 17's effective length L2=7.6 mm, the width w2=0.08 mm, the width w1=0.055 mm and the thickness t=0.045 mm. This calculation indicates that the primary resonance frequency in the focus direction is 30 Hz, the primary resonance frequency in the tracking direction is 37 Hz and the buckling resonance frequency is 2.2 kHz. Herein, if the thickness t is adjusted so that the primary resonance frequency in the focus direction becomes 37 Hz, as is the case with the conventional resilient supporting member 61 formed by only the straight portion, then in the resilient supporting member 6 according to this embodiment, the primary resonance frequency in the tracking direction is 45.6 Hz. In the same way, if the thickness t is adjusted, the buckling resonance frequency is 2.7 kHz. Therefore, compared with the conventional resilient supporting member 61 formed by only the straight portion in which the primary resonance frequency in the tracking direction is 50 Hz, in this embodiment, the primary resonance frequency in the tracking direction is reduced by 9%. Hence, if the resilient deformation portion 14 is provided with the trapezoidal portion 17, the power consumption which will be affected by the square of a spring constant can be decreased by about 20 percent. On the other hand, compared with the conventional resilient supporting member 61 formed by only the straight portion 15 in which the buckling resonance frequency is 3.6 kHz, in this embodiment, the buckling resonance frequency is 2.7 kHz, which is lower than the former. However, its value is still sufficiently greater than the gain crossover frequency (usually, set at a range from 500 Hz to 1.5 kHz) which is a frequency at which the servo gain becomes zero. Hence, this frequency is not lowered to the level at which the servo characteristic may be affected. In other words, the buckling resonance frequency is maintained at the level where the servo characteristic will not get worse while the ratio of the primary resonance frequency in the tracking direction to the primary resonance frequency in the focus direction can be lowered.

In the resilient deformation portion 14 according to the first embodiment, the width w1 of the narrowest part of the trapezoidal portion 17 is 1.2 times as great as the thickness t. However, in most of the area of the resilient deformation portion 14, the width is 1.3 or more times as great as the thickness t. This value does not reach the level at which the productivity can be deteriorated in sheet-metal press working. Therefore, the productivity can be kept, and simultaneously, the primary resonance frequency in the tracking direction can be reduced.

As described so far, in the objective lens drive 101 according to the first embodiment, the resilient supporting member 6 is provided with the trapezoidal portion 17. Therefore, without lowering the buckling resonance frequency largely, the primary resonance frequency in the tracking direction can be reduced. As a result, the servo characteristic can be maintained while the power consumption can be decreased.

Incidentally, in the first embodiment, on the side of the front-end portion 13 of the resilient supporting member 6, the straight portion 15 is provided, but the configuration is not limited to this. Specifically, the whole area of the resilient deformation portion 14 may be the trapezoidal portion 17. In that case, one end has a width of w1 and the other end has a width of w2. This configuration also presents the same advantages.

### Second Embodiment

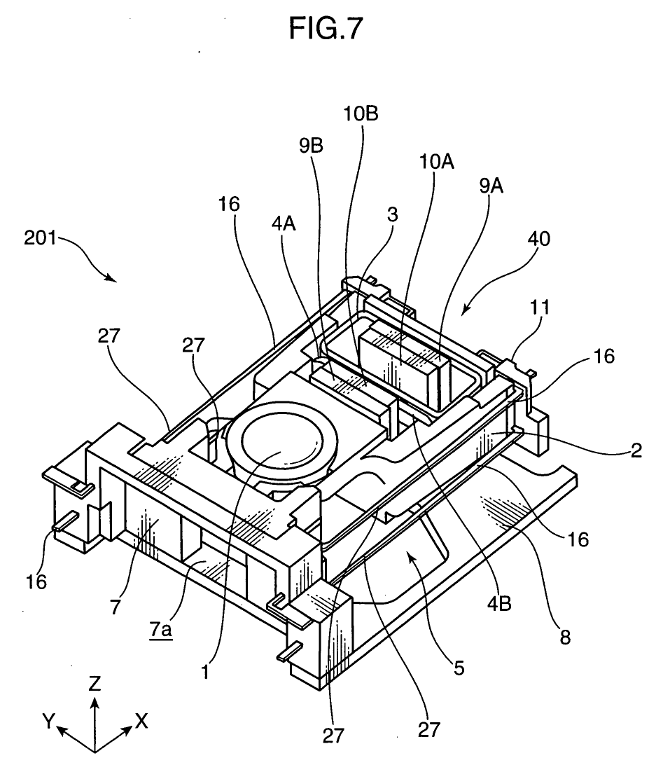

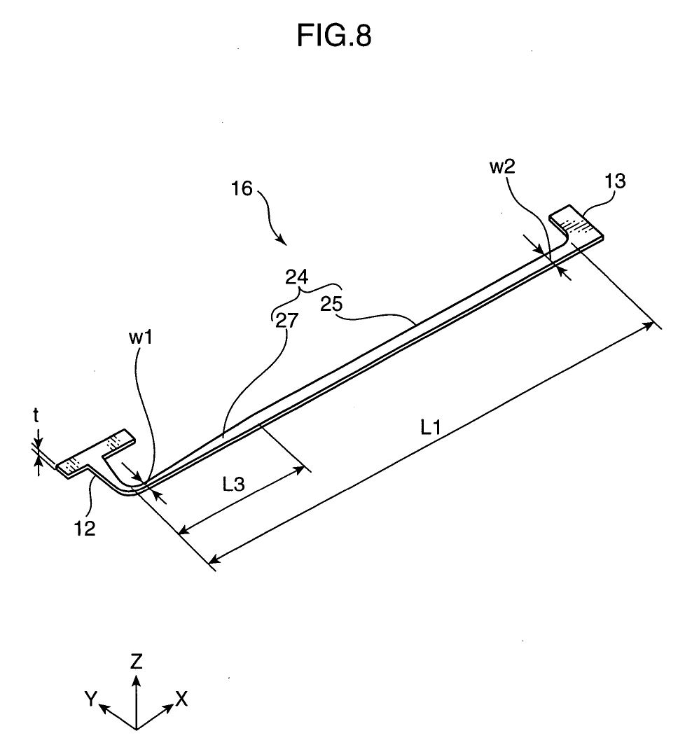

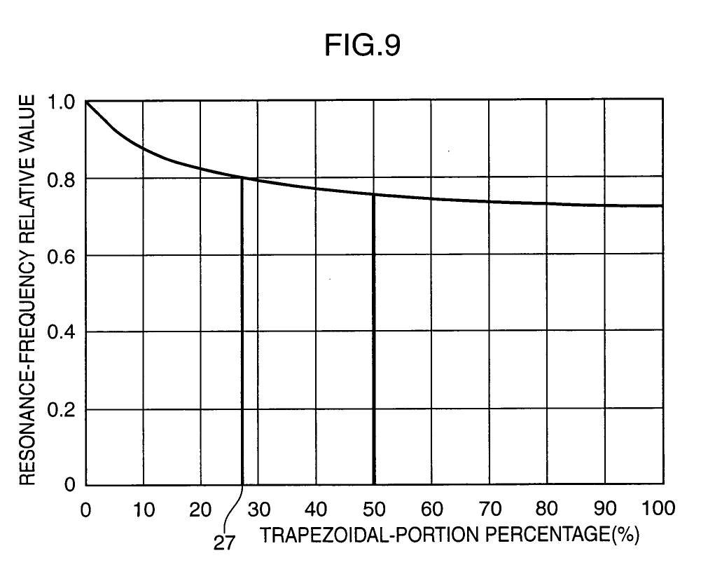

FIG. 7 shows an objective lens drive 201 according to a second embodiment of the present invention. FIG. 8 is a perspective view of a resilient supporting member 16, though a part of it is omitted, provided in the objective lens drive 201 of FIG. 7. FIG. 9 shows a result which is obtained by numerically calculating a primary resonance frequency in the tracking direction, using the finite element method, in the objective lens drive 201 of FIG. 7. The resilient supporting member 16 is disposed in a biaxial actuator which supports an objective lens 1 so that it can be freely displaced in the focus direction and in the tracking direction. Herein, component elements are given the same reference characters and numerals as those according to the prior art shown in FIG. 15 to FIG. 18, and thus, their detailed description is omitted.

In FIG. 7 and FIG. 8, the resilient supporting member 16 is formed by blanking a metal plate in sheet-metal press working. This metal plate is made of phosphor bronze, beryllium copper or the like, and thus, it is excellent in both conductivity and spring characteristics. One end of the resilient supporting member 16 is soldered to the focus coil 3 and the tracking coils 4A and 4B, so that an electric current can be sent thereto.

As shown in FIG. 8, in each resilient supporting member 16, a straight portion 25 and a trapezoidal portion 27 are provided in a resilient deformation portion 24. The resilient deformation portion 24 is formed in a straight line. The straight portion 25 is linked to a front-end portion 13 of the resilient supporting member 16. The trapezoidal portion 27 is linked to a base-end portion 12 of the resilient supporting member 16. In the trapezoidal portion 27, the end part on the side of the straight portion 25 has a width w2 while the end on the side of the base-end portion 12 has a width w1 narrower than the width w2.

After being formed in sheet-metal press working, the resilient supporting member 16 is united, by means of insertion molding, with an objective lens holder 2 and a securing member 7 which are molded out of resin.

This second embodiment is different from the first embodiment, in the following respect. An effective length L3 of the trapezoidal portion 27 is set to be equal to, or below, the half of an effective length L1 of the resilient supporting member 16, in other words, 50% or under. Besides, the effective length L3 is set to be equal to, or above, 27% of the effective length L1. The reason why it is set like this is described below.

In terms of the objective lens drive 201 including the resilient supporting member 16 shown in FIG. 8, a resonance frequency is numerically calculated using the finite element method. This numerical calculation is made by assuming the resilient deformation portion 24's effective length L1=8.6 mm, the trapezoidal portion 27's effective length L3=3.0 mm, the width w2=0.08 mm, w1=0.055 mm and the thickness t=0.045 mm. In other words, in this numerical calculation, the ratio of the effective length L1 to the effective length L3 is set at 35%. This numerical calculation indicates that the primary resonance frequency in the tracking direction is 38 Hz. As can be seen from this result, even in the second embodiment where the length of the wide straight portion 25 is five or more times as great as that of the objective lens drive 101 according to the first embodiment, the primary resonance frequency in the tracking direction is almost equal to that of the first embodiment.

In addition, together with the above described numerical calculation, a numerical calculation is also made by changing the ratio of the effective length L1 to the effective length L3 from 0% to 100%. This result is shown in FIG. 9. In FIG. 9, the horizontal axis indicates the trapezoidal portion's percentage, or the ratio of the effective length L1 to the effective length L3. The vertical axis indicates the relative value of the primary resonance frequency in the tracking direction. This relative value is a value relative to the primary resonance frequency set at 1.0 in the case where only the straight portion 25 is provided without the trapezoidal portion 27. As shown in FIG. 9, the relative value is 0.8 at the point where the trapezoidal-portion percentage is 27%. If the trapezoidal-portion percentage is 27% or over, it is seen that the primary resonance frequency in the tracking direction can be effectively reduced. Then, if the trapezoidal-portion percentage exceeds 50%, even though the percentage rises, that will not lower the primary resonance frequency in the tracking direction so much. Hence, within the range where the trapezoidal-portion percentage is beyond 50%, little change is made in the primary resonance frequency in the tracking direction. However, the greater the trapezoidal-portion percentage becomes, the larger the resilient deformation portion 24's narrow area will be. Thus, within the range where the trapezoidal-portion percentage exceeds 50%, productivity may be lowered for the resilient supporting member 16. Therefore, the trapezoidal-portion percentage is set at 27% or above as well as 50% or below, so that the primary resonance frequency in the tracking direction can be effectively reduced. At the same time, the yield can be restrained from being reduced at the time of sheet-metal press working.

As described so far, in the objective lens drive 201 according to the second embodiment, the trapezoidal portion 27 is formed in the resilient deformation portion 24 of the resilient supporting member 16. This trapezoidal portion 27's effective length L3 is set at 27-50% of the resilient deformation portion 24's effective length L1. This helps offer the resilient supporting member 16 a larger wide straight portion, and effectively lower the primary resonance frequency in the tracking direction. Consequently, in addition to the advantage according to the first embodiment, productivity can be enhanced for the resilient supporting member 16 in sheet-metal press working.

This second embodiment's summary will be described below.

(1) The above described trapezoidal portion has a length of 27% or above of the effective length of the above described resilient supporting member. Therefore, the primary resonance frequency in the tracking direction can be effectively reduced.

(2) The resilient supporting member is formed in sheet-metal press working. The above described trapezoidal portion has a length of 50% or below of the effective length of the above described resilient supporting member. Therefore, the yield can be restrained from becoming lower at the time of the sheet-metal press working. This makes it possible to stably produce the resilient supporting member.

Incidentally, the other configurations, operation and advantages are the same as those of the first embodiment. Thus, herein, a detailed description is omitted.

### Third Embodiment

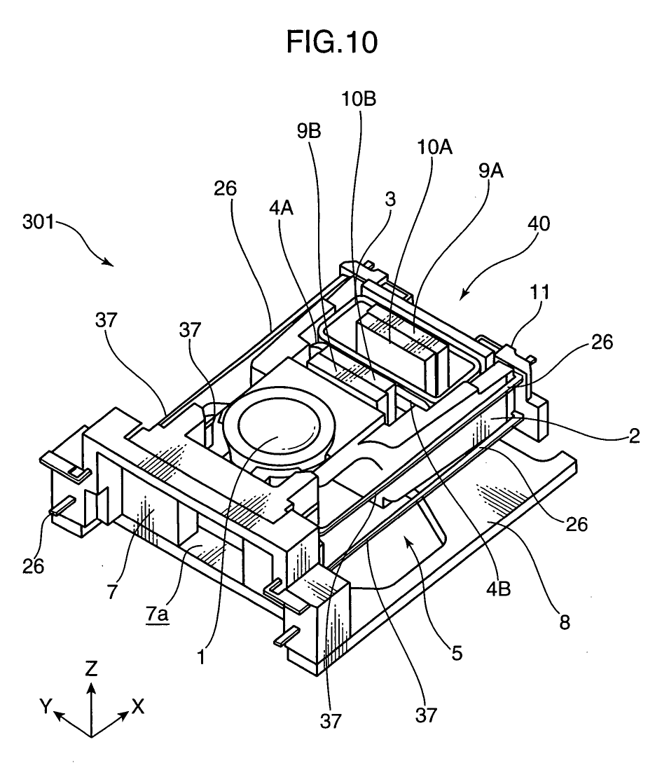

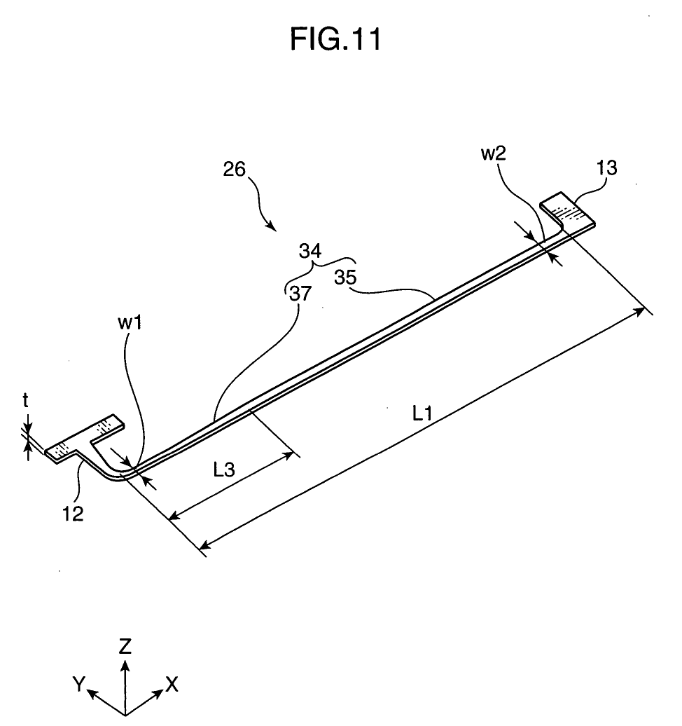

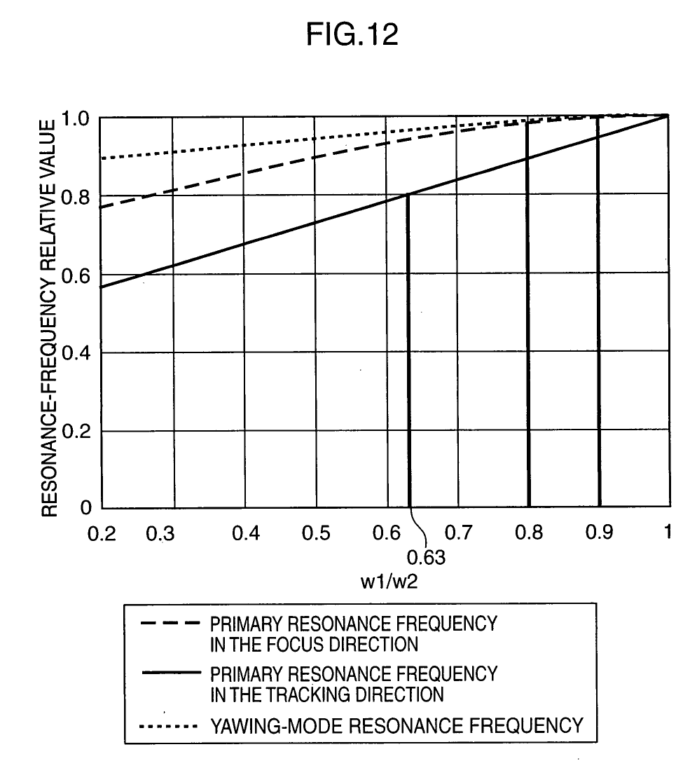

FIG. 10 shows an objective lens drive 301 according to a third embodiment of the present invention. FIG. 11 is a perspective view of a resilient supporting member 26, though a part of it is omitted, provided in the objective lens drive 301 of FIG. 10. FIG. 12 shows a result which is obtained by numerically calculating a primary resonance frequency in the tracking direction, using the finite element method, in the objective lens drive 301 of FIG. 10. The resilient supporting member 26 is disposed in a biaxial actuator which supports an objective lens 1 so that it can be freely displaced in the focus direction and in the tracking direction. Herein, component elements are given the same reference characters and numerals as those according to the prior art shown in FIG. 15 to FIG. 18, and thus, their detailed description is omitted.

In FIG. 10 and FIG. 11, the resilient supporting member 26 is formed by blanking a metal plate in sheet-metal press working. This metal plate is made of phosphor bronze, beryllium copper or the like, and thus, it is excellent in both conductivity and spring characteristics. One end of the resilient supporting member 26 is soldered to the focus coil 3 and the tracking coils 4A and 4B, so that an electric current can be sent thereto.

As shown in FIG. 11, in each resilient supporting member 26, a straight portion 35 and a trapezoidal portion 37 are provided in a resilient deformation portion 34. The resilient deformation portion 34 is formed in a straight line. The straight portion 35 is linked to a front-end portion 13 of the resilient supporting member 26. The trapezoidal portion 37 is linked to a base-end portion 12 of the resilient supporting member 26. In the trapezoidal portion 37, the end part on the side of the straight portion 35 has a width w2 while the end on the side of the base-end portion 12 has a width w1 narrower than the width w2.

After being formed in sheet-metal press working, the resilient supporting member 26 is united, by means of insertion molding, with an objective lens holder 2 and a securing member 7 which are molded out of resin.

In this third embodiment, the trapezoidal portion 37 is formed so that the relation between a width w2 at the widest part in the trapezoidal portion 37 and a width w1 at the narrowest part in the trapezoidal portion 37 satisfies the following expression (1).
0.63≦w1/w2≦0.9 (1)

The reason why the widths w1, w2 at both ends in the trapezoidal portion 37 have been set to satisfy this expression (1) will be described below.

In the trapezoidal portion 37, if the width w1 at the narrowest part is shortened, the primary resonance frequency in the tracking direction becomes lower, but productivity goes down at the time of sheet-metal press working. This may also affect the primary resonance frequency in the focus direction or the buckling resonance frequency. Therefore, by changing the ratio of the width w1 to the width w2, at that time, the primary resonance frequency in the focus direction, the primary resonance frequency in the tracking direction and the buckling resonance frequency (i.e., the yawing-mode resonance frequency) are calculated using the finite element method. This calculation is made by assuming the resilient deformation portion 34's effective length L1=8.6 mm, the trapezoidal portion 37's effective length L3=3.0 mm, the width w2=0.08 mm and the thickness t=0.045 mm.

This result is shown in FIG. 12. In FIG. 12, the horizontal axis indicates the ratio w1/w2 and the vertical axis indicates the relative value of the resonance frequency. This relative value is a value relative to the resonance frequency set at 1 when the ratio w1/w2 is 1.

As can be seen from FIG. 12, if the ratio w1/w2 is 0.9, the relative value of the primary resonance frequency in the tracking direction can be reduced by approximately 5%. Hence, within the range below this, it is said that the power consumption can be somewhat decreased. Preferably, therefore, the ratio w1/w2 should be 0.9 or lower. Then, if the ratio w1/w2 is 0.8 or below, the relative value of the primary resonance frequency in the tracking direction can be lowered by around 10%. Thus, the power consumption can be effectively decreased. Hence, it is more desirable that the ratio w1/w2 be 0.8 or lower. Incidentally, if the ratio w1/w2 is 0.8 or above, the primary resonance frequency in the focus direction and the yawing-mode resonance frequency remain substantially without being lowered. In contrast, only the primary resonance frequency in the tracking direction is reduced.

On the other hand, if the ratio w1/w2 goes down, productivity may be affected at the time of sheet-metal press working. Specifically, in the case of the width w1=0.050 mm or below at which the ratio of the width w1 to the thickness t becomes equal to 1.1 or below, the productivity may be deteriorated. Thus, preferably, the ratio w1/w2 should be 0.63 or above. Incidentally, in this third embodiment, the effective length of L3 is designed to be about 35% of the resilient deformation portion 34. However, a similar tendency can be obtained, even if the effective length of L3 is set otherwise.

As described so far, in the objective lens drive 301 according to the third embodiment, the resilient supporting member 26 is provided with the trapezoidal portion 37. Then, the relation between the width w2 in the straight portion 35 of the resilient deformation portion 34 and the width w1 at the narrowest part of the trapezoidal portion 37 satisfies the above described expression (1). Therefore, only the primary resonance frequency in the tracking direction can be reduced while the primary resonance frequency in the focus direction and the yawing-mode resonance frequency can be kept from being lowered.

This third embodiment's summary will be described below.

(1) The above described trapezoidal portion is designed so that if the widest part in the tracking direction has a width of w1 and the narrowest part in the tracking direction has a width of w2, the ratio w1/w2 becomes 0.9 or below. Therefore, the power consumption can be effectively decreased.

(2) The above described trapezoidal portion is designed so that the above described ratio w1/w2 becomes 0.8 or below. Therefore, the power consumption can be effectively reduced.

(3) The above described resilient supporting member is formed in sheet-metal press working. The above described trapezoidal portion is designed so that the above described ratio w1/w2 becomes 0.65 or above. Therefore, the yield can be restrained from becoming lower at the time of the sheet-metal press working.

Incidentally, the other configurations, operation and advantages are the same as those of the first embodiment. Thus, herein, a detailed description is omitted.

### Fourth Embodiment

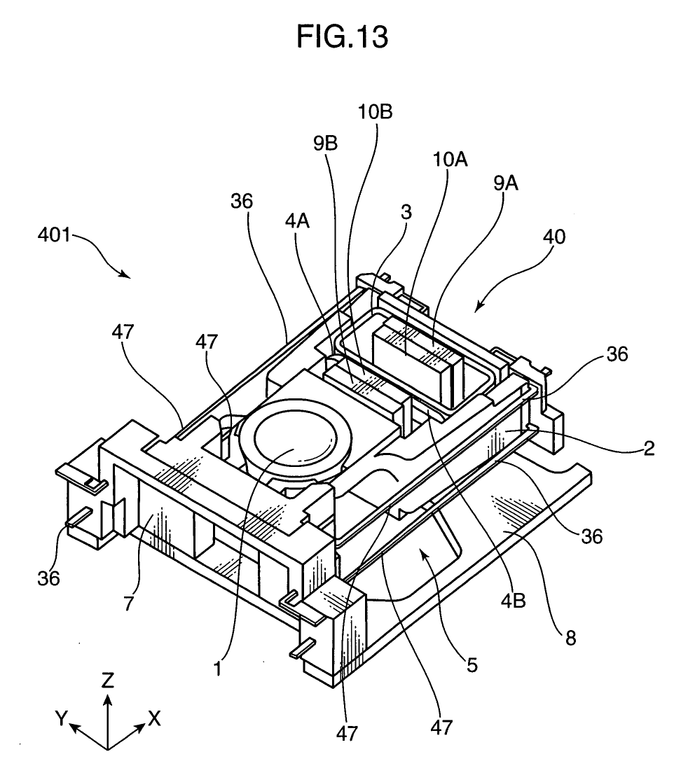

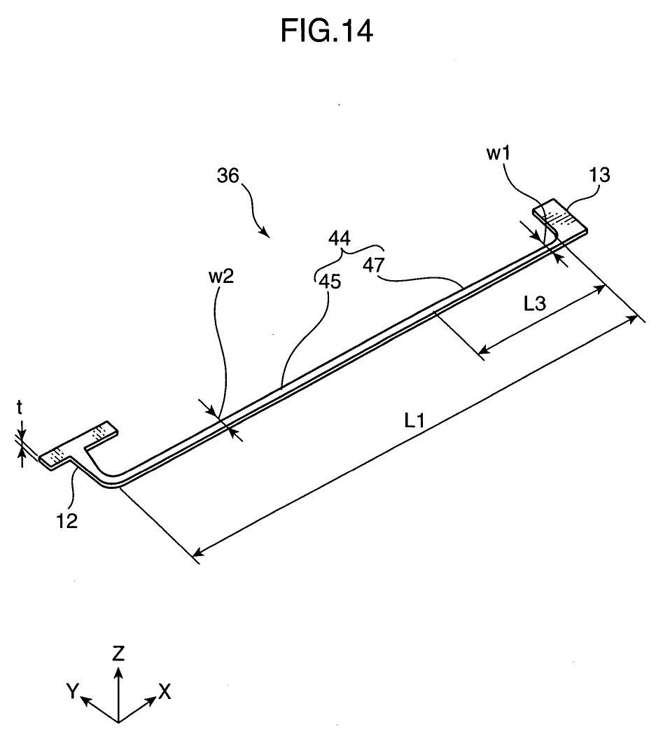

FIG. 13 shows an objective lens drive 401 according to a fourth embodiment of the present invention. FIG. 14 is a perspective view of a resilient supporting member 36, though a part of it is omitted, provided in the objective lens drive 401 of FIG. 13. The resilient supporting member 36 is disposed in a biaxial actuator which supports an objective lens 1 so that it can be freely displaced in the focus direction and in the tracking direction. Herein, component elements are given the same reference characters and numerals as those according to the prior art shown in FIG. 15 to FIG. 18, and thus, their detailed description is omitted.

In FIG. 13 and FIG. 14, the resilient supporting member 36 is formed by blanking a metal plate in sheet-metal press working. This metal plate is made of phosphor bronze, beryllium copper or the like, and thus, it is excellent in both conductivity and spring characteristics. One end of the resilient supporting member 36 is soldered to the focus coil 3 and the tracking coils 4A and 4B, so that an electric current can be sent thereto.

After being formed in sheet-metal press working, the resilient supporting member 36 is united, by means of insertion molding, with an objective lens holder 2 and a securing member 7 which are molded out of resin.

As shown in FIG. 14, in the resilient supporting member 36, a straight portion 45 and a trapezoidal portion 47 are provided in a resilient deformation portion 44. The resilient deformation portion 44 is formed in a straight line. In this fourth embodiment, the trapezoidal portion 47 is provided on the side of a front-end portion 13 of the straight portion 45, different from any of the first to third embodiments. Specifically, the straight portion 45 is linked to a base-end portion 12 of the resilient supporting member 36. This straight portion 45 has a width w2. Then, the trapezoidal portion 47 is linked to the straight portion 45 on the side of the front-end portion 13. The trapezoidal portion 47 has the width w2 on the side of the straight portion 45 and becomes narrower toward the front-end portion 13. Then, the trapezoidal portion 47 has a width w1 at the point where it is linked to the front-end portion 13 of the resilient supporting member 36.

In a resonance mode at the buckling resonance frequency, as shown in FIG. 6, the resilient supporting member 36 is largely deformed on the side of the base-end portion 12 near the securing member 7. In this way, the side on which it is largely deformed is set to the wide straight portion 45, and the trapezoidal portion 47 is formed on the side of the front-end portion 13 where the objective lens holder 2 is supported. In such a resilient supporting member 36 as configured like this according to this embodiment, the influence on the buckling resonance frequency can be reduced.

Herein, in terms of the objective lens drive 401 according to this embodiment, a resonance frequency is numerically calculated using the finite element method. This numerical calculation is made by assuming the resilient deformation portion 44's effective length L1=8.6 mm, the trapezoidal portion 47's effective length L3=3.0 mm, the width w2=0.08 mm, w1=0.065 mm and the thickness t=0.045 mm, a comparison is made between the case in which the trapezoidal portion 47 is disposed on the side of the front-end portion 13 in the straight portion 45 and the case in which it is disposed on the side of the base-end portion 12 in the straight portion 45.

As a result, if the trapezoidal portion 47 is placed on the side of the front-end portion 13, the primary resonance frequency in the focus direction is 34 Hz, the primary resonance frequency in the tracking direction is 39 Hz and the buckling resonance frequency is 2.9 kHz. In contrast, if the trapezoidal portion 47 is placed on the side of the base-end portion 12, the primary resonance frequency in the focus direction is 35 Hz, the primary resonance frequency in the tracking direction is 39 Hz and the buckling resonance frequency is 2.5 kHz. In short, it can be seen that if the trapezoidal portion 47 is located on the side of the front-end portion 13 where the objective lens holder 2 is supported, then the buckling resonance frequency is set to a high level.

As described so far, in the objective lens drive 401 according to the fourth embodiment, the trapezoidal portion 47 is formed on the side of the front-end portion 13 of the resilient supporting member 36. Therefore, the buckling resonance frequency can be set to a higher level. This helps offer a more stable servo characteristic.

This fourth embodiment's summary will be described below. The above described trapezoidal portion has such a shape that the width in the tracking direction becomes narrower at the end on the side where a lens holder is held. Therefore, the buckling resonance frequency can be set to a higher level, thus offering a more stable servo characteristic.

Incidentally, the other configurations, operation and advantages are the same as those of the first embodiment. Thus, herein, a detailed description is omitted.

### INDUSTRIAL APPLICABILITY

The present invention is useful for an objective lens drive which displaces an objective lens in the focus direction and tracking direction, through bending deformation of resilient supporting members.

1-8. (canceled)

9. An objective lens drive in which an objective lens holder is held to a plurality of resilient supporting members supported on a securing member, and an objective lens secured to this objective lens holder is displaced in a focus direction and a tracking direction through bending deformation of the resilient supporting members, comprising,
a trapezoidal portion provided in each resilient supporting member, the trapezoidal portion having a width in the tracking direction becoming narrower toward an end of the resilient supporting member.

10. The objective lens drive according to claim 9, wherein the trapezoidal portion has a length of 27% or above of an effective length of the resilient supporting member.

11. The objective lens drive according to claim 10, wherein:
the resilient supporting member is formed in sheet-metal press working; and
the trapezoidal portion has a length of 50% or below of the effective length of the resilient supporting member.

12. The objective lens drive according to claim 9, wherein in the trapezoidal portion, if the narrowest part in the tracking direction has a width of w1 and the widest part in the tracking direction has a width of w2, a ratio w1/w2 is 0.9 or below.

13. The objective lens drive according to claim 12, wherein in the trapezoidal portion, the ratio w1/w2 is 0.8 or below.

14. The objective lens drive according to claim 12, wherein:
the resilient supporting member is formed in sheet-metal press working; and
in the trapezoidal portion, the ratio w1/w2 is 0.65 or above.

15. The objective lens drive according to claim 9, wherein the trapezoidal portion is shaped so that at an end on a side of the securing member, the width in the tracking direction becomes narrower.

16. The objective lens drive according to claim 9, wherein the trapezoidal portion is shaped so that at an end on a side where the objective lens holder is held, the width in the tracking direction becomes narrower.
